(19) United States
(12) Patent Application Publication
(10) Pub. No.: US 2003/0182186 A1
(43) Pub. Date: Sep. 25, 2003

(54) Method of attracting customer

(76) Inventor: Aharon Winter, Kfar Mimon (IL)

Correspondence Address: BROWDY AND NEIMARK, P.L.L.C., 624 NINTH STREET, NW, SUITE 300, WASHINGTON, DC, 20001-5303, US

(21) Appl. No.: 10/101,500

(22) Filed: Mar. 20, 2002

(51) Int. Cl. G06F 17/60

(52) U.S. Cl. 705/14; 705/21

(57) ABSTRACT

A method for drawing potential customers to a point of sale comprising providing at the point of sale a set of travelers' aids according to a pre-determined list and displaying a symbol in the vicinity of the point of sale, wherein the symbol represents the presence of the set of travellers' aids at the point of sale. A traveler in need of one or more items in the set of travelers' aids and seeing the symbol will proceed to the point of sale.

### FIELD OF THE INVENTION

This invention relates to a method for drawing customers into a commercial enterprise.

### BACKGROUND OF THE INVENTION

Society has become very transportation-oriented. At any one time, millions of people are on the road for short or extended periods of time. Often, people while travelling are in need of various items which are not readily available to the traveler, such as buttons, spot-remover, tampons, etc. Each of these items must be procured in a different store.

The term “first-aid” is well known, and a first aid kit contains a set of pre-determined medical assistance items for various medical emergencies. It would be helpful if a corresponding set of travellers' aids or “secondary-aid” would also be widely available to the traveler.

### SUMMARY OF THE INVENTION

It is an object of the present invention to provide a method for attracting customers to a point of sale.

In one aspect of the invention, there is provided a method for drawing potential customers to a point of sale. The method comprises (a) providing at the point of sale a set of travelers' aids according to a pre-determined list; and (b) displaying a symbol in the vicinity of the point of sale, wherein the symbol represents the presence of the set of travellers' aids at the point of sale; wherein a traveler in need of one or more items in the set of travelers' aids and seeing the symbol will proceed to the point of sale.

In accordance with this aspect of the invention, a symbol is displayed in the vicinity of the point of sale.

The symbol may be any image or sign, with or without letters or words, which will become connected in the mind of the traveler with the presence of the set of travelers' aids, similarly to the images of a man and a woman side by side, or the letters “W.C.” or “OO” representing the presence of a restroom. The symbol does not necessarily have to have an obvious meaning, and may consist of any shape or form which through advertising and use has acquired a distinctiveness which differentiates it from other symbols.

The symbol may be displayed at the point of sale itself and/or a certain distance therefrom, such as next to a road leading to the point-of-sale, so that a traveler will know that a set of travelers' aids is close-by.

Examples of a point-of-sale which may be used in the method of the invention include an automobile service station, a commodity store, a restaurant, a drugstore, a supermarket, a superpharm, etc. The point-of-sale will generally offer various products or services for sale other than and in addition to the travelers' aids, using the presence of the travelers' aids to abut customers which would otherwise not have entered the point-of-sale to procure these products or services. In other words, the method of the invention uses the travelers' aids as bait with which to lure customers to purchase the products or services offered at the point-of-sale.

Non-limiting examples of items which could be included in a list of travelers' aids include (1) clothing apparatus such as disposable underwear, patches and safety pins; (2) sewing equipment such as thread, needle and buttons; (3) feminine hygienic products such as tampons and sanitary napkins; (4) appearance improving equipment such as brush, comb, lipstick, mirror and spot-remover; (5) freshening-up products such as deodorant, toothbrush and toothpaste, disposable moist tissues, facial tissues, chap-stick and soap; (6) infant and child care products such as diapers, toilet paper, talc, baby oil and pacifiers; (7) OTC products such as aspirin, pain-killers and antidiarrhea; and (8) shoeware products such as shoelaces, heels, shoe brush and shoe polish. In general, food products are not required items on the list, but may also be included. In a preferred embodiment, the list does not include food products.

Preferably, the pre-determined list will include at least one of the above categories of items. More preferably, the list will include at least three of the categories of items. Most preferably, the list will include at least five of the categories of items.

The items may be kept at the point of sale in a special box or cabinet, or on one or more shelves.

In operation of the method, a traveler in need of one or more of the travelers' aids, seeing the displayed symbol and knowing what it represents, will proceed to and enter the point of sale in order to acquire the required items. At the same time, he will see what is offered for sale at the point of sale and may buy one or more items on sale. In this way, customers who otherwise would not have entered the point of sale are attracted to enter and buy things there.

Also provided by the invention is a set of travelers' aids for use in the method of the invention comprising items from at least two of the following categories: clothing apparatus, sewing equipment, feminine hygienic products, appearance improving equipment, freshening-up products, infant and child care products, OTC products and shoeware.

In another aspect of the invention, there is provided a method of franchising a method according to the invention to a proprietor of a point of sale comprising:

(a) providing a predetermined list of travelers' aids and a symbol;

(b) allowing the proprietor to display the symbol and requiring the proprietor to keep in his point of sale the travelers' aids appearing in the list; and

(c) receiving from the proprietor a compensation for being allowed to display the symbol.

In order to practice this aspect of the invention, one who wishes to grant a franchise to others (hereinafter: “the granter”) draws up a list of travelers' aids and chooses an appropriate symbol. Preferably, the granter will advertise the symbol and its meaning, i.e. the presence of travelers' aids. The granter will come into contact with retailers and proprietors of various points of sale who are interested in displaying the symbol in the vicinity of their enterprise. The proprietors will undertake to keep on stock all of the items of the pre-determined list of travelers' aids and will pay the granter a compensation for allowing them to display the symbol.

### BRIEF DESCRIPTION OF THE DRAWING

In order to understand the invention and to see how it may be carried out in practice, a preferred embodiment will now be described, by way of non-limiting example only, with reference to the accompanying drawing, in which:

FIG. 1 is a schematic illustration of a point of sale displaying a symbol according to one embodiment of the method of the invention.

### DETAILED DESCRIPTION OF THE INVENTION

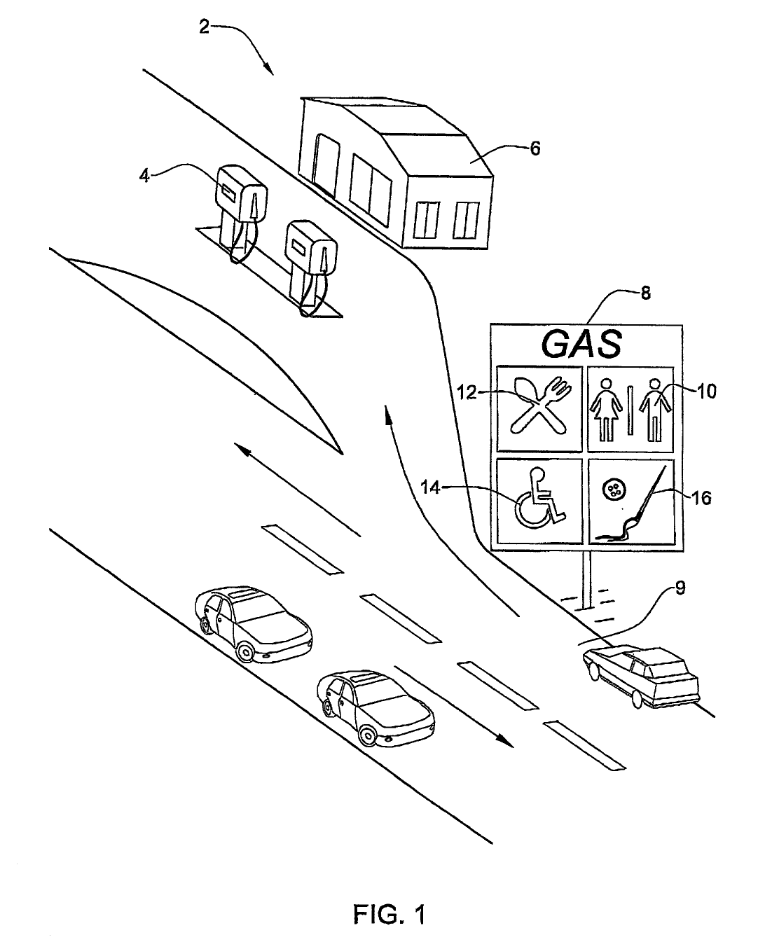

One embodiment of the invention is illustrated in FIG. 1 which shows a point-of-sale in the form of an automobile service station, represented in general by the numeral 2, comprising gasoline pumps 4, a building 6 housing the station office and a shop, and a display sign 8. The display sign is located on the side of a road 9 leading to the station, and can be seen by one traveling along the road prior to his arrival at the station. The display sign comprises symbols representing various services offered by the station, such as a restroom 10, restaurant 12 and facilities for the disabled 14. The display sign also has a symbol 16 representing the presence at the station of a set of travellers' aids according to the invention. The symbol illustrated in FIG. 1 is in the form of a button, needle and had, but this is only one example, and the symbol may consist of any form, shape and/or letters or symbols, or combinations thereof.

A traveler traveling along the road and seeing the sign will remember that he is in need of a travelers' aid, such as a button, shoelace, comb or aspirin. He will then turn into the station in order to purchase the item which he needs. At the same time, he will also buy gasoline for his car, which he otherwise may have done only on reaching a further service station. In this way, a customer was attracted to the service station to buy gasoline.

1. A method for drawing potential customers to a point of sale comprising:
(a) providing at said point of sale a set of travelers' aids according to a pre-determined list; and
(b) displaying a symbol in the vicinity of sad point of sale, wherein said symbol represents the presence of said set of travellers' aids at said point of sale;
wherein a traveler in need of one or more items in said set of travelers' aids and seeing said symbol will proceed to said point of sale.

2. A method according to claim 1 wherein said set of travelers' aids comprises at least one of the following: clothing apparatus, sewing equipment, feminine hygienic products, appearance improving equipment, freshening-up products, infant and child care products, OTC products and shoeware.

3. A method according to claim 1 wherein said point of sale is selected from an automobile service station, a commodity store, a restaurant, a drugstore, a supermarket, and a superpharm.

4. A set of travelers' aids for use in the method of claim 1 comprising items from at least two of the following categories: clothing apparatus, sewing equipment, feminine hygienic products, appearance improving equipment, freshening-up products, infant and child care products, OTC products and shoeware.

5. A method of franchising a method according to claim 1 to a proprietor of a point of sale comprising:
(a) providing a pre-determined list of travelers' aids and a symbol;
(b) allowing said proprietor to display said symbol and requiring said proprietor to keep in his point of sale the travelers' aids appearing in the list; and
(c) receiving from said proprietor a compensation for being allowed to display the symbol.
